(19) United States
(12) Patent Application Publication
(10) Pub. No.: US 2010/0285780 A1
(43) Pub. Date: Nov. 11, 2010

(54) CALL TIME MONITORING AND WARNING GENERATION

(76) Inventor: William H. Collins, Apex, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(21) Appl. No.: 11/939,100

(22) Filed: Nov. 13, 2007

(51) Int. Cl. H04M 3/42; H04W 64/00; G08B 21/00

(52) U.S. Cl. 455/414.1; 379/201.06; 455/456.1; 340/540

(57) ABSTRACT

A system and method for call time warning generation that includes a telephony device that includes a processor and a memory. During initiation of a call from the device to a destination party, the device determines if a current time is within a do-not-call time and provides a warning if the call is during the do-not-call time before the call is sent.

### BACKGROUND OF THE INVENTION

The present invention is related to phone calls, and more specifically to call time monitoring and warning generation.

Currently, people travel extensively around the world for business and for pleasure. Also, nearly everyone has a phone of some kind, either wired or wireless. Today, not only do many adults carry cell phones, but it is quite common for children even in their early teens to have a cell phone with them the majority of the time. This allows people to keep in communication worldwide regardless of where they or their desired called party may be located. However, a problem arises when a person places a call to a called party in another time zone at a time that happens to be an undesirable time in the called party's time zone. For example, a person in one country and one time zone may place a call to another person, friend or family member in another time zone in another country where the call is actually received at the called party in the middle of the night while the called party is sleeping.

FIG. 1 shows a time zone map of the world. As shown in the map 100, the countries of the world and portions thereof may fall into any one or more of multiple time zones. A person in Japan for example as denoted by the “S” (source of call) 101 in a time zone 102 may initiate a call to a called party “D” 103 in New York that is in a different time zone 104. As can be seen from looking at the scale along the bottom of the world map 100, there may be a fourteen hour difference between the time zone 102 where Japan is located and the time zone 104 where New York is located. A person “S” 101 in Japan on business may have just gotten out of a very successful business meeting and wants to call his spouse to share the good news where his spouse “D” 103 is located in New York. Therefore, at 5 p.m. Japan time the caller “S” 101 in time zone 102 initiates a call to his spouse “D” 103 in New York in time zone 104. The call is received by his spouse at 3:00 a.m. New York time causing his spouse to likely be awakened from her sleep by the call. This is an undesirable time to receive a telephone call barring an emergency situation. It is not uncommon for a person to forget about the time difference between a current location and the called party's location or to miscalculate the time difference, resulting in calls being received at undesirable times.

### BRIEF SUMMARY OF THE INVENTION

According to one aspect of the present invention, a telephony device includes a processor, and a memory, wherein during initiation of a call from the device to a destination party, the device determines if a current time is within a do-not-call time and provides a warning if the call is during the do-not-call time before the call is sent.

According to another aspect of the present invention, a method for call time warning generation includes detecting an initiation of a call at a device, determining if a current time is within a do-not-call time, and providing a warning if the call is during the do-not-call time before the call is sent.

According to a further aspect of the present invention, a system includes a server, a telephony device, and a network, the server and the telephony device communicating over the network, wherein during initiation of a call from the device to a destination party, the device receives an indication from the server, responsive to a request from the device, whether the call should be sent, the device providing a warning responsive to the indication being “do not call” before the call is sent.

According to a still further aspect of the present invention, a computer program product comprising a computer useable medium having computer useable program code embodied therewith, the computer useable program code comprising computer useable program code configured to detect an initiation of a call at a device, computer useable program code configured to determine if a current time is within a do-not-call time, and computer useable program code configured to provide a warning if the call is during the do-not-call time before the call is sent.

### BRIEF DESCRIPTION OF THE DRAWINGS

The present invention is further described in the detailed description which follows in reference to the noted plurality of drawings by way of non-limiting examples of embodiments of the present invention in which like reference numerals represent similar parts throughout the several views of the drawings and wherein:

FIG. 1 is a time zone map of the world;

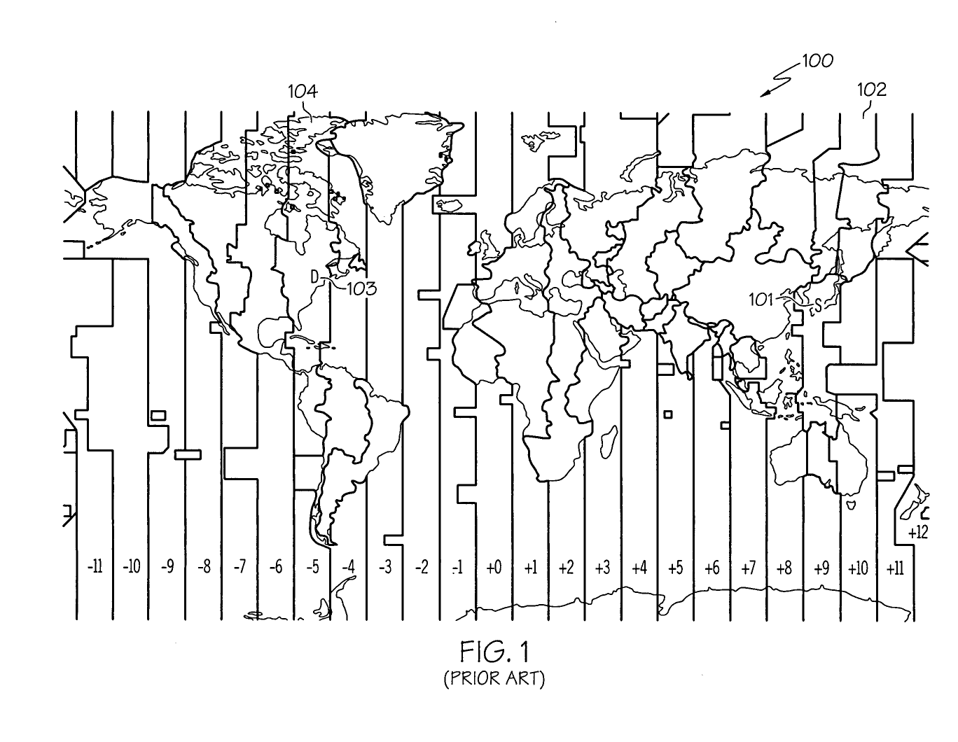

FIG. 2 is a diagram of a flowchart for call time warning generation according to an example embodiment of the present invention;

FIG. 3 is a flowchart of a process for call time warning generation according to another example embodiment of the present invention;

FIG. 4 is a diagram of a system for call time warning generation according to an example embodiment of the present invention;

FIG. 5 is a flowchart of a process for call time warning generation with location server according to still another example embodiment of the present invention;

FIG. 6 is a flowchart of a process for call time warning generation in a client according to an example embodiment of the present invention; and

FIG. 7 is a flowchart of a process for call time warning generation in a server according to an example embodiment of the present invention.

### DETAILED DESCRIPTION OF THE INVENTION

As will be appreciated by one of skill in the art, the present invention may be embodied as a method, system, computer program product, or a combination of the foregoing. Accordingly, the present invention may take the form of an entirely hardware embodiment, an entirely software embodiment (including firmware, resident software, micro-code, etc.) or an embodiment combining software and hardware aspects that may generally be referred to herein as a “system.” Furthermore, the present invention may take the form of a computer program product on a computer-usable storage medium having computer-usable program code embodied in the medium.

Any suitable computer usable or computer readable medium may be utilized. The computer usable or computer readable medium may be, for example but not limited to, an electronic, magnetic, optical, electromagnetic, infrared, or semiconductor system, apparatus, device, or propagation medium. More specific examples (a non-exhaustive list) of the computer readable medium would include the following: an electrical connection having one or more wires; a tangible medium such as a portable computer diskette, a hard disk, a random access memory (RAM), a read-only memory (ROM), an erasable programmable read-only memory (EPROM or Flash memory), a compact disc read-only memory (CD-ROM), or other tangible optical or magnetic storage device; or transmission media such as those supporting the Internet or an intranet. Note that the computer usable or computer readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

In the context of this document, a computer usable or computer readable medium may be any medium that can contain, store, communicate, propagate, or transport the program for use by or in connection with the instruction execution system, platform, apparatus, or device. The computer usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, radio frequency (RF) or other means.

Computer program code for carrying out operations of the present invention may be written in an object oriented, scripted or unscripted programming language such as Java, Perl, Smalltalk, C++ or the like. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the functions/acts specified in the flowchart and/or block diagram block or blocks. Alternatively, computer program implemented steps or acts may be combined with operator or human implemented steps or acts in order to carry out an embodiment of the invention.

Embodiments according to the present invention relate to providing a warning to a user before placing phone calls at undesirable times in the time zone of the party being called (hereinafter the “called party”). In the description below, the terms called party and destination party may be used to denote a party to which a phone call is directed. The warning may typically be a popup on a display of the user's phone or may be an audible or any other type of warning. Upon initiation of a call, it is determined in what time zone the called party is located and if this is determined to be an undesirable time in the called party's time zone, a warning message may be displayed alerting the user making the call that this may be an undesirable time to call the called party.

An application may detect the initiation of a call and identify a time zone of the called party. If the application is resident on the caller's phone, it may be part of a phonebook application of the phone or may be an independent or separate application of the phone. The application may include time zones of the called party or location information of the called party. The time zone of the called party may be identified from pre-stored information stored on the phone and associated with the called party, or may be identified based on any one or more of a country code, a city code, an area code, or a Global Positioning System (GPS) location of the called party. Once the time zone of the called party is identified, the application may then determine a time in the time zone of the called party based on a current time in the time zone of the calling party, and issue a warning to the calling party if the time in the time zone of the called party is an undesirable time.

Moreover, according to embodiments of the present invention, a location of a called party may be obtained from a server and sent to a phone of the calling party. This location information may then be used to determine a time zone of the called party. In addition, according to embodiments of the present invention, upon initiation of a call to a called party, a request may be sent from a phone (client) of the caller to a server to verify that the call is being made and at an appropriate time for the called party. The server may have access to a current location of the called party from information stored at the server, from information stored at other servers, from information stored at social networking sites, from information stored on websites, or from other sources. In addition, the called party may have indicated times that are not desirable for receiving calls and this information may have been stored or sent to one or more servers, websites or social networking sites. Therefore, a server may use this information to determine if the call is being made at a desirable time for the called party and may simply respond to the caller with an “okay to call” indication or a “do not call” indication. The caller may then act accordingly. In this scenario, the caller's phone does not receive location information of the called party and merely receives an okay to call or do not call response from a server, providing more privacy for the called party.

Moreover, according to embodiments of the present invention, users may register their do not call times with a server, a website, or a social networking site. For example, people may enter their location and/or do not call times on social networks such as Facebook, MySpace, Orkut, etc. In this regard, once registered, the phones of the registered parties may report location information of the phone to the server. The server may use this information and possibly other information to determine whether it is a desirable time to call each user. The server may receive location information from a called party's phone such as GPS location or may monitor websites such as social networks to obtain location information for a called party. This is advantageous since people are constantly moving and traveling where their location is very seldom stable.

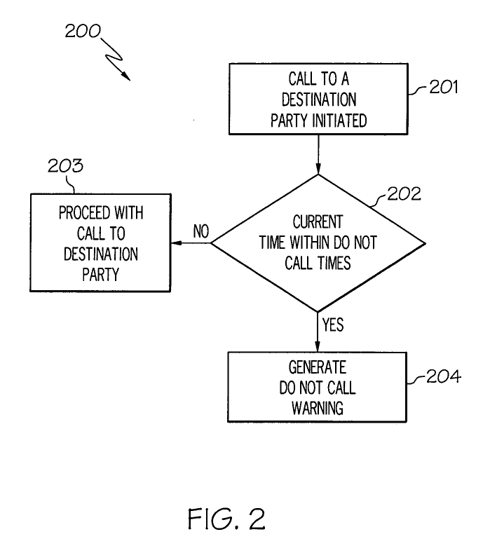

FIG. 2 shows a diagram of a flowchart for call time warning generation according to an example embodiment of the present invention. In the process 200, in block 201, a call to a destination party may be initiated. In block 202, it may be determined whether a current time is within do not call times for the destination party, and if not in block 203, the call may proceed to the destination party. If in block 202 it is determined that the call is within do not call times, then in block 204 a do not call warning may be generated and displayed or otherwise given to an initiator of the call.

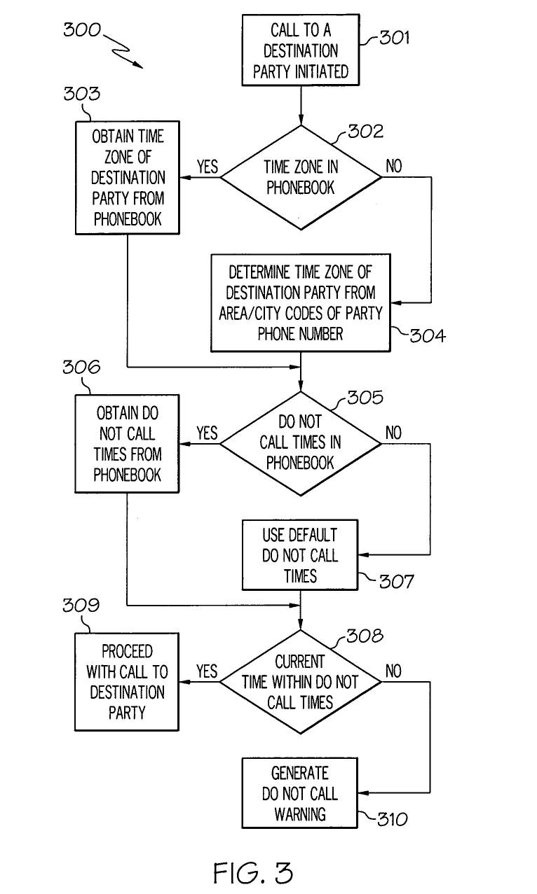

FIG. 3 shows a flowchart of a process for call time warning generation according to another example embodiment of the present invention. In the process 300, in block 301 a call to a destination party is initiated. In block 302, it may be determined whether a time zone of the destination party is in a phonebook application, and if so, in block 303, the time zone of the destination party is obtained from the phonebook application. The phonebook may be an application running in a phone of the party initiating the call. If the time zone of the destination party is not in the phonebook application, in block 304, the time zone of the destination party may be determined from country, area, or city codes of the destination party phone number. In block 305, it may be determined if do not call times for the destination party are in a phonebook application, and if not, in block 307, default do not call times may be used. Default do not call times may have been setup by a user and stored in the user's phone based on geographical areas, area codes, or any other criteria. If do not call times for the destination party are in a phonebook, then in block 306 the do not call times for the destination party are obtained from the phonebook. In block 308, it may be determined whether a current time is within a do not call time, and if not, in block 309 the call to the destination party may proceed. If the current time is within the do not call times, in block 310, a do not call warning may be generated to the initiator of the call. The do not call warning may be in the form of a pop-up display or any other type of displayed message, or may be an audible or any other type of warning (e.g., blinking light, flashing screen, etc.).

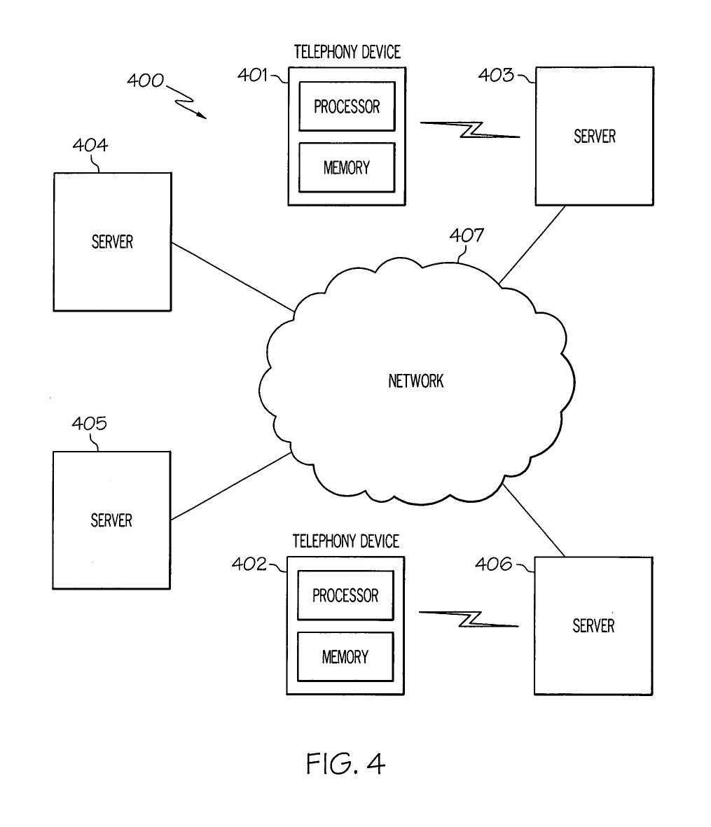

FIG. 4 shows a diagram of a system for call time warning generation according to an example embodiment of the present invention. The system 400 may include one or more telephony devices 401, 402 where each telephony device may include at a minimum a processor and a memory. Further, the system may include one or more servers 403 through 406 and a network 407 that provides interconnection and allows communication between the one or more telephony devices 401, 402 and the one or more servers 403-406. A call may be initiated at a first telephony device 401 to a destination party at a second telephony device 402 where the second telephony device 402 may be located in a different time zone from the first telephony device 401. Upon initiation of the call, at the first telephony device 401, a request may be sent by the first telephony device 401 to a server 403-406 requesting either location information of the destination party (i.e., second telephony device 402) or an indication whether the call is okay to be made based on stored or registered do not call times from the destination party or a time in the time zone of the destination party. Upon receiving one or more of this information from the server 403-406, the caller using the telephony device 401 may receive an indication from the server 403-406 at the telephony device 401 if the call is being made at a do not call time, or may receive location information of the destination party from the server 403-406 such that the first telephony device 401 may make a determination whether the current time is within a do not call time. A server 403-406 may get information from other servers regarding do not call times of the destination party and/or a current location of the destination party. Different parties may register their current location and/or do not call times with a server, or may submit this information to websites or social networking sites. Upon initiation of a call, this information may be retrieved by one server from another server, or may be already stored at the particular server.

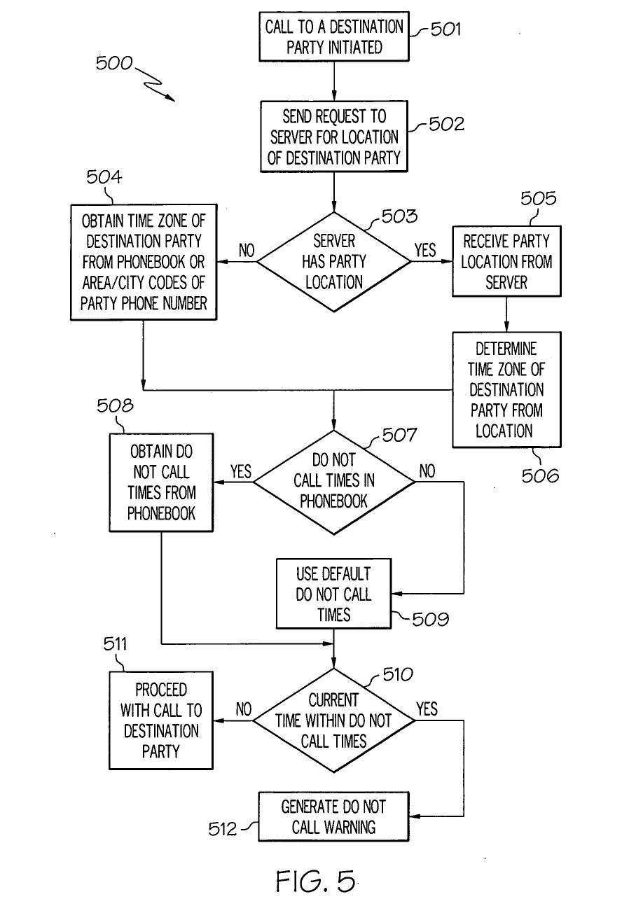

FIG. 5 shows a flowchart of a process for call time warning generation with location server according to still another example embodiment of the present invention. In the process 500, in block 501, a call to a destination party may be initiated. In block 502, a request may be sent to a server for a location of a destination party. In block 503, it may be determined whether the server has a location of the destination party, and if not, in block 504 a time zone of the destination party may be obtained from a phonebook application or from country, area, or city codes of the destination party phone number. If the server has the destination party location, in block 505, the destination party location may be sent from the server to the telephony device initiating the call where it is received from the server. In block 506, a time zone of the destination party may be determined from the location information received from the server. In block 507, it may be determined if do not call times for the destination party are stored in a phonebook application and if so, in block 508, the do not call times for the destination party may be obtained from the phonebook application. In this regard, an initiator of the call to the destination party may have entered and pre-stored do not call times associated with the destination party in the phonebook application. If do not call times for the destination party are not in a phonebook application, in block 509 default do not call times may be used. In this regard, an initiator of the call to the destination party may have entered pre-stored default do not call times based on a geographic location or country, area, or city codes associated with the phone number. In block 510, it may be determined whether a current time is within the do not call times, and if not, in block 511, the call may proceed to the destination party. If the current time is within the do not call times, then in block 512, a do not call warning may be generated to the initiator of the call.

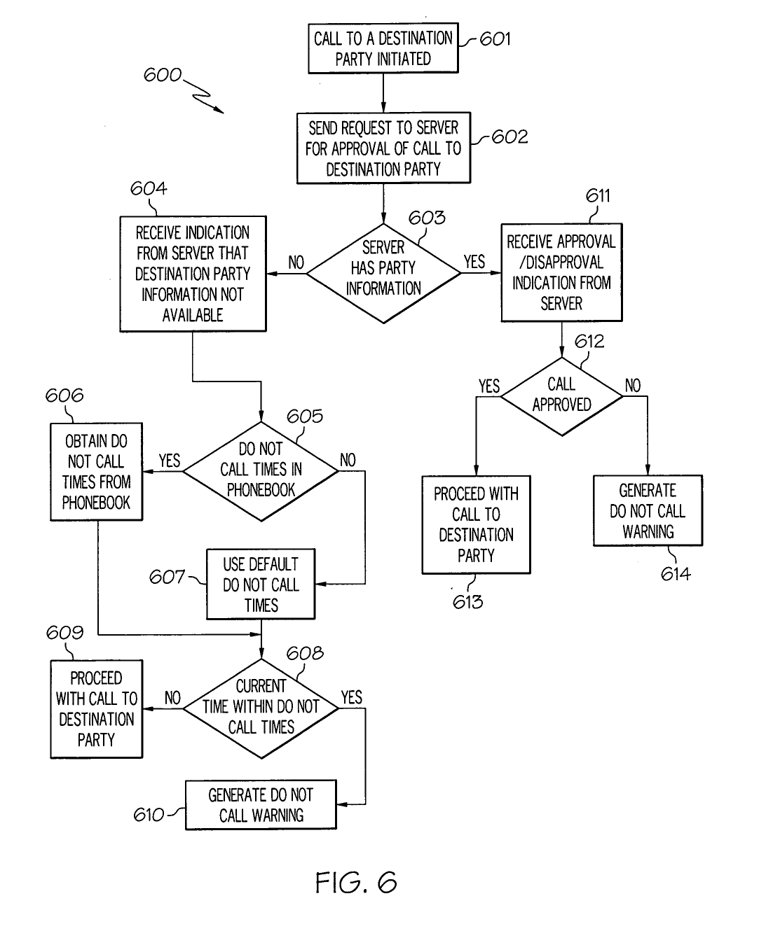

FIG. 6 shows a flowchart of a process for call time warning generation in a client according to an example embodiment of the present invention. In the process 600, in block 601, a call to a destination party may be initiated. In block 602 a request may be sent to a server for approval of a call to a destination party. In block 603 it may be determined if the server has information for the destination party and if so, in block 611, the client device (i.e., telephony device of a user initiating the call) may receive an approval/disapproval indication from the server. In block 612, a determination is made whether the call to the destination party has been approved by the server and if so, in block 613, the call may proceed to the destination party. If the call has not been approved, then in block 614, a do not call warning may be generated to the initiator of the call by the client device.

If the server does not have information for the destination party, then in block 604, the client device may receive an indication from the server that the destination party information is not available. Then, in block 605, it may be determined whether do not call times are available in a phonebook application and if not, in block 607, default do not call times may be used. If do not call times are available, then in block 606, the do not call times may be obtained from the phonebook application. In block 608, it may then be determined whether the current time is within do not call times and if not, in block 609, the call may proceed to the destination party. If the current time is within do not call times, then in block 610, a do not call warning may be generated to an initiator of the call. In this example embodiment, privacy for the destination party is enhanced since a location of the destination party is not provided from the server to the client device.

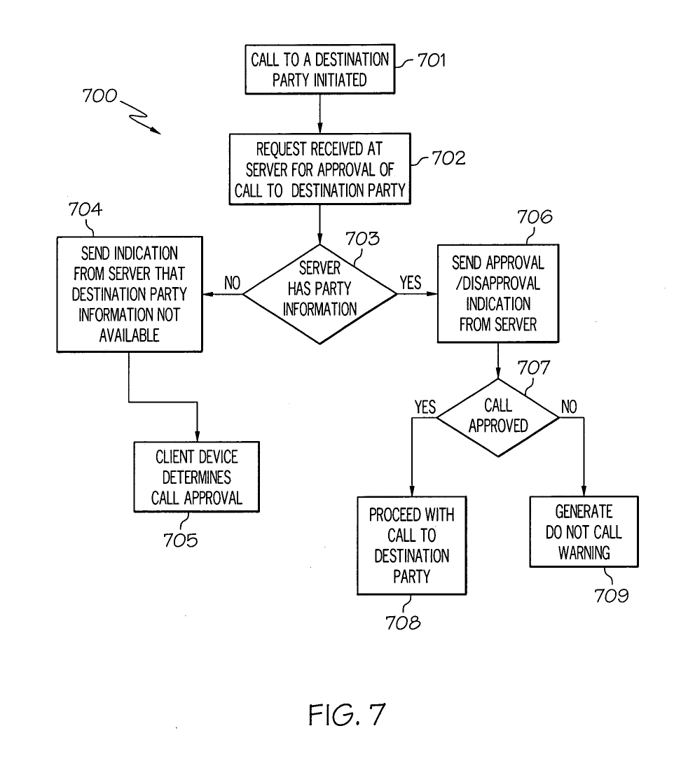

FIG. 7 shows a flowchart of a process for call time warning generation in a server according to an example embodiment of the present invention. This server process supports the client process shown in FIG. 6. In the process 700, in block 701, a call to a destination party may be initiated. In block 702, a request may be received at a server from a client device (i.e., telephony device initiating the call) for approval of the call to the destination party. In block 703, it may be determined if the server has information on the destination party and if so, in block 706, an approval/disapproval indication may be sent from the server to the client device. Then in block 707, it may be determined at the client device whether the call has been approved based on the indication from the server and if so, in block 708, the call may proceed to the destination party. If the call has not been approved, then in block 709, a do not call warning may be generated and issued to the initiator of the call.

If the server does not have information on the destination party, then in block 704, the server may send an indication that the destination party information is not available. Then, in block 705, the client device performs processing to determine call approval. Therefore, a destination party privacy is enhanced since a location of the destination party is not sent from the server to the client.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A telephony device comprising:
a processor; and
a memory,
wherein during initiation of a call from the device to a destination party, the device determines if a current time is within a do-not-call time and provides a warning if the call is during the do-not-call time before the call is sent.

2. The device according to claim 1, further comprising a phonebook application stored in the memory, the phonebook application determining if the current time is within the do-not-call time and providing the warning to a user of the device if the call is during the do-not-call time before the call is sent.

3. The device according to claim 1, further comprising the device using default times stored in the memory to determine if the current time is within the do-not-call time.

4. The device according to claim 3, wherein the default times are set by a user of the device.

5. The device according to claim 1, further comprising the device receiving a current location of the destination party from a server and using the current location to determine if the current time is within the do-not-call time.

6. A method for call time warning generation comprising:
detecting an initiation of a call at a device;
determining if a current time is within a do-not-call time; and
providing a warning if the call is during the do-not-call time before the call is sent.

7. The method according to claim 6, further comprising identifying a time zone of a destination of the call before determining if the current time is within the do-not-call time.

8. The method according to claim 6, further comprising obtaining the do-not-call time from a phonebook in the device.

9. The method according to claim 6, further comprising obtaining the do-not-call time from default times stored in the device.

10. The method according to claim 6, further comprising obtaining a current location of a destination party associated with the call and storing the current location.

11. The method according to claim 6, further comprising obtaining a current Global Positioning System (GPS) location of the destination party associated with the call and storing the current GPS location.

12. The method according to claim 11, further comprising identifying a time zone of the GPS location before determining if the current time is within the do-not-call time.

13. The method according to claim 11, further comprising obtaining the current location of the destination party associated with the call from at least one of a server or a social networking site.

14. The method according to claim 6, further comprising sending a request to a server regarding whether a call to a destination party associated with the call can be made during the current time, obtaining the do-not-call time from information stored on the server provided by the destination party, and receiving a response from the server indicating one of approval or disapproval of the initiation of the call.

15. The method according to claim 6, further comprising receiving a request for information regarding a destination party associated with the call at a server, determining whether the destination party information is available, determining if the current time is within the do-not-call time using the destination party information when available, and sending a response from the server indicating one of approval or disapproval of the initiation of the call when the destination party information is available.

16. A system comprising:
a server;
a telephony device; and
a network, the server and the telephony device communicating over the network,
wherein during initiation of a call from the telephony device to a destination party, the telephony device receives an indication from the server, responsive to a request from the telephony device, whether the call should be sent, the telephony device providing a warning responsive to the indication being “do not call” before the call is sent.

17. The system according to claim 16, wherein the server determines if a current time is within a do-not-call time and provides the “do not call” indication when the current time is within a do-not-call time and provides an “okay to call” indication when the current time is not within the do-not-call time.

18. The system according to claim 16, wherein the server determines if information for the destination party is stored at the server and provides to the device one of the indication whether the call should be sent when information for the destination party is stored at the server or the indication comprising information for the destination party is not available.

19. The system according to claim 16, further comprising receiving information from the destination party at the server indicating do-not-call times for the destination party.

20. The system according to claim 16, further comprising the server obtaining location information of the destination party and generating the indication responsive to the location information.
